(19) United States
(12) Patent Application Publication
(10) Pub. No.: US 2025/0102310 A1
(43) Pub. Date: Mar. 27, 2025

(54) ROUTE COMPUTATION APPARATUS, ROUTE COMPUTATION METHOD, AND NON-TRANSITORY STORAGE MEDIUM

(71) Applicant: NEC Corporation, Minato-ku, Tokyo (JP)

(72) Inventors: Tingting Dong, Tokyo (JP); Jianquan Liu, Tokyo (JP); Ryo Kawai, Tokyo (JP); Satoshi Yamazaki, Tokyo (JP); Noboru Yoshida, Tokyo (JP); Karen Stephen, Tokyo (JP); Naoki Shindou, Tokyo (JP); Yuta Namiki, Tokyo (JP); Youhei Sasaki, Tokyo (JP)

(73) Assignee: NEC Corporation, Minato-ku, Tokyo (JP)

(21) Appl. No.: 18/833,974

(22) PCT Filed: Mar. 10, 2022
(86) PCT No.: PCT/JP2022/010595

§ 371 Date: Jul. 29, 2024

(51) Int. Cl. G01C 21/34; G01C 21/36; G06T 7/70; G06V 20/52; G06V 40/10

(52) U.S. Cl. CPC G01C 21/3461; G01C 21/3492; G01C 21/3602; G01C 21/3647; G06T 7/70; G06V 20/53; G06V 40/10; G06T 2207/30196; G06T 2207/30232; G06T 2207/30242

(57) ABSTRACT

A route computation apparatus (10) according to the present invention includes: an acquisition unit (11) that acquires people distribution information indicating a distribution state of persons in a passageway through which a user travels; a computation unit (12) that computes, based on the people distribution information, a preferable route, on the passageway, satisfying a condition defined based on a distance to another person, the preferable route being a route on the passageway indicating a travel location in a width direction of the passageway; and an output unit (13) that outputs preferable route information indicating the computed preferable route.

### TECHNICAL FIELD

The present invention relates to a route computation apparatus, a route computation method, and a storage medium.

### BACKGROUND ART

Techniques relating to the present invention are disclosed in Patent Document 1, Patent Document 2, and Non-Patent Document 1.

Patent Document 1 discloses a technique for searching for a route where a previously-set avoidance area is avoided and outputting the searched route.

Patent Document 2 discloses a technique for computing a feature value of each of a plurality of keypoints of a human body included in an image, and thereby searching, based on the computed feature value, for an image including a human body with a similar pose or a human body exhibiting a similar movement or collectively classifying human bodies in which the pose or movement is similar.

Non-Patent Document 1 discloses a technique relating to skeleton estimation of a person.

### RELATED DOCUMENT

### Patent Document

Patent Document 1: Japanese Patent Application Publication No. 2020-67311

Patent Document 2: International Patent Publication No. WO2021/084677

### Non-Patent Document

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, P. 7291-7299

### DISCLOSURE OF THE INVENTION

### Technical Problem

In a case where virus infection and the like are considered, traveling is preferably made by sufficiently retaining a distance to a surrounding person. However, a passerby does not easily determine, by him/herself, through what location on a passageway the passerby travels.

The technique disclosed in Patent Document 1 is a technique for searching for an optimal passageway passed in order to go from a start point to a goal point, but is not a technique for computing through what location on a passageway travelling is preferably made. In such a technique disclosed in Patent Document 1, a passerby can recognize an optimal passageway, but there is a problem in that it is difficult to recognize through what location on a passageway travelling is preferably made.

Further, the techniques disclosed in Patent Document 2 and Non-Patent Document 1 are a technique relating to skeleton estimation of a person, but are not a technique for computing through what location on a passageway travelling is preferably made. In such techniques disclosed in Patent Document 2 and Non-Patent Document 1, there is a problem in that it is difficult for a passerby to recognize through what location on a passageway travelling is preferably made.

In view of the above-described problems, one example of an object of the present invention is to provide a route computation apparatus, a route computation method, and a storage medium that solve an issue in that a passerby can easily recognize through what location on a passageway traveling is preferably made.

### Solution to Problem

According to one aspect of the present invention, provided is a route computation apparatus including:

an acquisition unit that acquires people distribution information indicating a distribution state of persons in a passageway through which a user travels;

a computation unit that computes, based on the people distribution information, a preferable route, on the passageway, satisfying a condition defined based on a distance to another person, the preferable route being a route on the passageway indicating a travel location in a width direction of the passageway; and

an output unit that outputs preferable route information indicating the computed preferable route.

According to one aspect of the present invention, provided is a route computation method including,

by a computer:
acquiring people distribution information indicating a distribution state of persons in a passageway through which a user travels;
computing, based on the people distribution information, a preferable route, on the passageway, satisfying a condition defined based on a distance to another person, the preferable route being a route on the passageway indicating a travel location in a width direction of the passageway; and
outputting preferable route information indicating the computed preferable route.

According to one aspect of the present invention, provided is a storage medium storing a program causing a computer to function as:

an acquisition unit that acquires people distribution information indicating a distribution state of persons in a passageway through which a user travels;

a computation unit that computes, based on the people distribution information, a preferable route, on the passageway, satisfying a condition defined based on a distance to another person, the preferable route being a route on the passageway indicating a travel location in a width direction of the passageway; and

an output unit that outputs preferable route information indicating the computed preferable route.

### Advantageous Effects of the Invention

According to one aspect of the present invention, a route computation apparatus, a route computation method, and a storage medium that solve an issue in that a passerby can easily recognize through what location on a passageway traveling is preferably made is achieved.

### BRIEF DESCRIPTION OF THE DRAWINGS

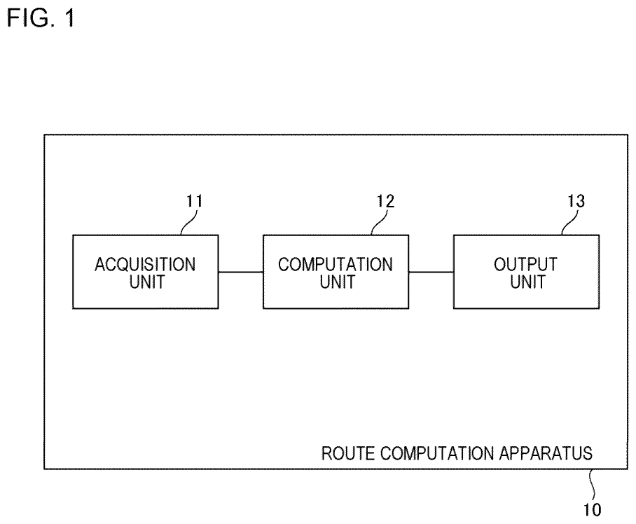

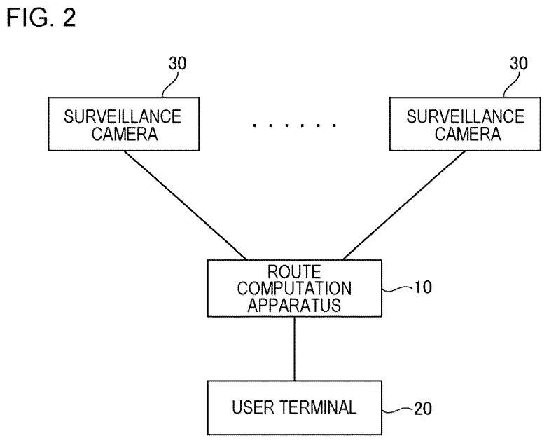

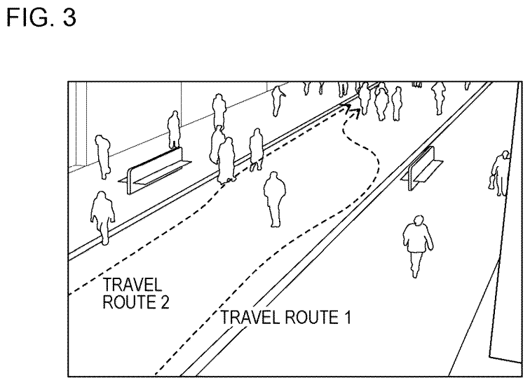

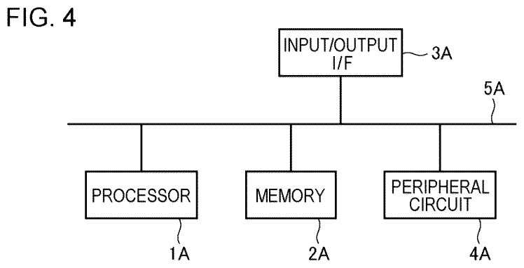

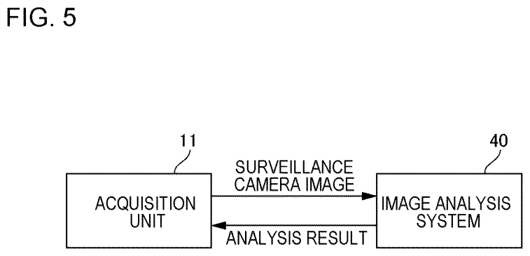

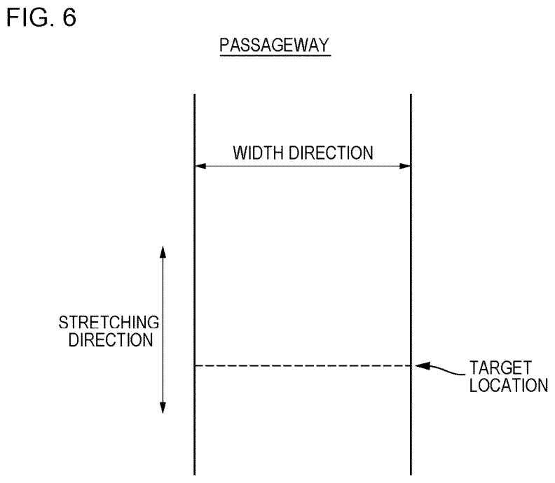

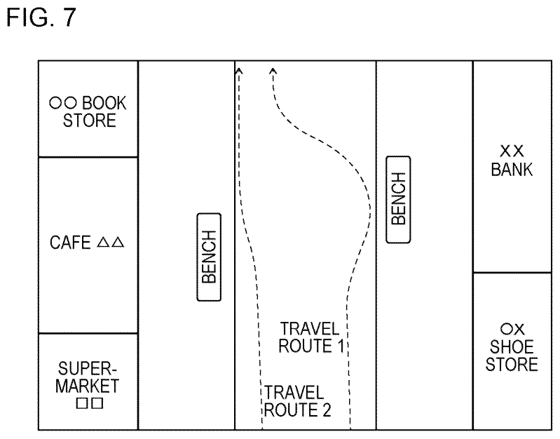

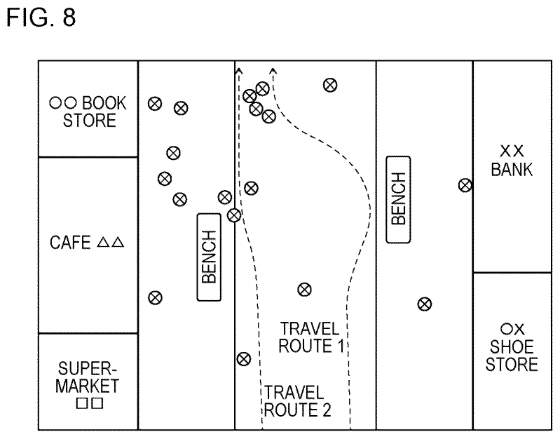

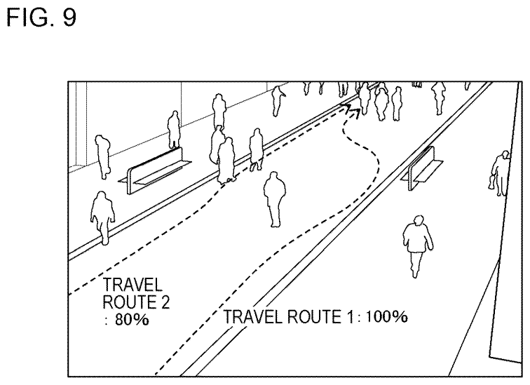

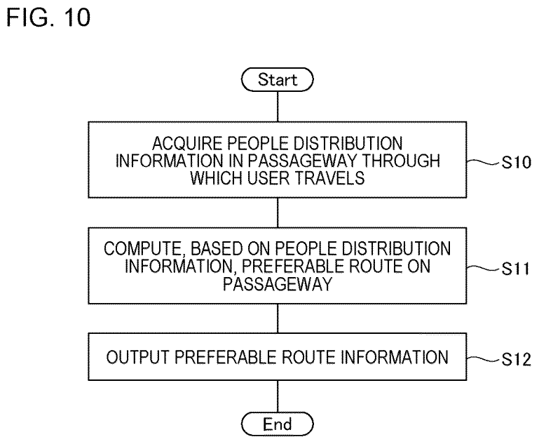

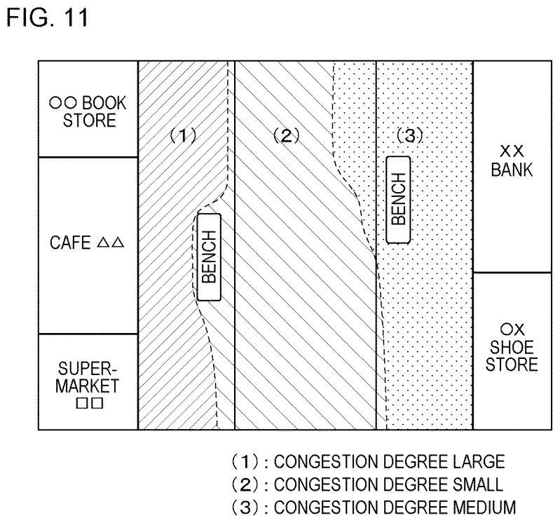

The above-described object, other objects, features, and advantages will become more apparent from public example embodiments described below and the following accompanying drawings.

[FIG. 1] It is a diagram illustrating one example of a function block diagram of a route computation apparatus.

[FIG. 2] It is a diagram illustrating another apparatus cooperating with the route computation apparatus.

[FIG. 3] It is a diagram illustrating one example of information output by the route computation apparatus.

[FIG. 4] It is a diagram illustrating one example of a hardware configuration of the route computation apparatus.

[FIG. 5] It is a diagram illustrating processing of an acquisition unit.

[FIG. 6] It is a diagram illustrating a content of words relating to a passageway.

[FIG. 7] It is a diagram illustrating another example of information output by the route computation apparatus.

[FIG. 8] It is a diagram illustrating another example of information output by the route computation apparatus.

[FIG. 9] It is a diagram illustrating another example of information output by the route computation apparatus.

[FIG. 10] It is a flowchart illustrating one example of a flow of processing of the route computation apparatus.

[FIG. 11] It is a diagram illustrating one example of information generated by the route computation apparatus.

### EXAMPLE EMBODIMENT

Hereinafter, example embodiments according to the present invention are described by using the accompanying drawings. Note that in all drawings, a similar component is assigned with a similar reference sign, and description thereof is omitted as appropriate.

### First Example Embodiment

FIG. 1 is a function block diagram illustrating an outline of a route computation apparatus 10 according to a first example embodiment. The route computation apparatus 10 includes an acquisition unit 11, a computation unit 12, and an output unit 13.

The acquisition unit 11 acquires people distribution information indicating a distribution state of persons in a passageway through which a user travels. The computation unit 12 computes, based on the people distribution information, a preferable route, on the passageway, satisfying a condition defined based on a distance to another person, the preferable route being a route on the passageway indicating a travel location in a width direction of the passageway. The output unit 13 outputs preferable route information indicating the computed preferable route.

According to the route computation apparatus 10 including such a configuration, an issue in that a passerby can recognize through what location on a passageway traveling is preferably made is solved.

### Second Example Embodiment

### “Outline”

A route computation apparatus 10 according to a second example embodiment is configured by further embodying the route computation apparatus 10 according to the first example embodiment. Herein, an outline of the route computation apparatus 10 is briefly described.

As illustrated in FIG. 2, the route computation apparatus 10 provides predetermined information for a user by cooperating with a user terminal 20 carried by the user and surveillance cameras 30 installed in each location on a passageway.

First, the route computation apparatus 10 analyzes an image (hereinafter, a “surveillance camera image”) generated by the surveillance camera 30 capturing an image of a location where a user is present, and thereby generates people distribution information indicating a distribution state of persons in a passageway through which the user travels. For determination of a location where a user is present, a current location positioning function mounted on the user terminal 20 may be used, or may be achieved by searching for a user in a surveillance camera image, by using a face authentication technique.

Next, the route computation apparatus 10 computes, based on the acquired people distribution information, a preferable route satisfying a condition defined based on a distance to another person, the preferable route being a route on a passageway, through which a user travels, indicating a travel location in a width direction of the passageway. The route computation apparatus 10 computes a preferable route sufficiently ensuring a distance to another person.

Then, the route computation apparatus 10 outputs preferable route information indicating the computed preferable route, and causes the user terminal 20 to display the preferable route information.

FIG. 3 illustrates one example of preferable route information displayed in the user terminal 20. A travel route 1 and a travel route 2 illustrated in FIG. 3 each are a preferable route provided for a user. A passageway broadens in a width direction (a right and left direction toward a stretching direction of a passageway). Therefore, in a case where traveling is made on the passageway, there are various options such as “traveling is made at a right end of the passageway”, “traveling is made at a left end of the passageway”, and “traveling is made in a middle of the passageway”. Further, there are an option in which traveling is made while the travel location is retained, and an option in which traveling is made while the travel location is changed (i.e., while the travel location is changed in a right and left direction toward a travel direction). A preferable route computed by the route computation apparatus 10 indicates, as illustrated in FIG. 3, through what location on the passageway broadening in the width direction traveling is made.

As is clear from FIG. 3 and the above description, a technique for computing a preferable route by using the route computation apparatus 10 and a technique for searching for an optimal passageway through which traveling is made in order to go from a start point to a goal point as disclosed in Patent Document 1 are clearly different in an achievement means thereof, an acquired resulting matter (computed result), and the like.

### “Hardware Configuration”

Next, one example of a hardware configuration of the route computation apparatus 10 is described. Each function units of the route computation apparatus 10 is achieved based on any combination of hardware and software mainly including a central processing unit (CPU) of any computer, a memory, a program loaded onto a memory, a storage unit (capable of storing, in addition to a program previously stored from a stage where an apparatus is shipped, a program downloaded from a storage medium such as a compact disc (CD), a server on the Internet, and the like) such as a hard disk storing the program, and a network-connection interface. Then, it can be understood by those of ordinary skill in the art that in an achievement method and an apparatus for the above, there are various modified examples.

FIG. 4 is a block diagram illustrating a hardware configuration of the route computation apparatus 10. As illustrated in FIG. 4, the route computation apparatus 10 includes a processor 1A, a memory 2A, an input/output interface 3A, a peripheral circuit 4A, and a bus 5A. The peripheral circuit 4A includes various modules. The route computation apparatus 10 does not necessarily include the peripheral circuit 4A. Note that, the route computation apparatus 10 may be configured by a plurality of apparatuses physically and/or logically separated. In this case, each of the plurality of apparatuses can include the above hardware configuration.

The bus 5A is a data transmission path through which the processor 1A, the memory 2A, the peripheral circuit 4A, and the input/output interface 3A mutually transmit/receive data. The processor 1A is an arithmetic processing apparatus, for example, such as a CPU and a graphics processing unit (GPU). The memory 2A is a memory, for example, such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can issue an instruction to each module, and perform an operation, based on operation results of the modules.

### “Function Configuration”

Next, a function configuration of the route computation apparatus 10 according to the second example embodiment is described in detail. FIG. 1 illustrates one example of a function block diagram of the route computation apparatus 10 according to the second example embodiment. As illustrated, the route computation apparatus 10 includes an acquisition unit 11, a computation unit 12, and an output unit 13.

The acquisition unit 11 acquires people distribution information indicating a distribution state of persons in a passageway through which a user travels.

According to the second example embodiment, a “passageway through which a user travels” is a passageway where a user is present. The acquisition unit 11 analyzes a surveillance camera image generated by the surveillance camera 30 capturing a location where a user is present, and thereby generates people distribution information indicating a distribution state of persons in a passageway through which the user travels. Hereinafter, the processing is described in detail.

—Determination of Location Where User is Present—For determination of a location where a user is present, a current location positioning function (a global positioning system (GPS) function or the like) may be used. In this case, the acquisition unit 11 receives, from the user terminal 20, location information indicating a current location measured by the user terminal 20, and determines, as a location where the user is present, a location indicated by the location information.

Further, determination of a location where a user is present may be achieved by searching, by using an image analysis technique, for a user in a surveillance camera image. In this case, a feature value (a face image, a feature value of a face, or the like) of the user is previously registered in the route computation apparatus 10. Then, the acquisition unit 11 searches, by using the feature value, for the user in the surveillance camera image. The acquisition unit 11 determines, as a location where the user is present, an image-capture location of the surveillance camera 30 generating the surveillance camera image in which the user is found. Search for the user in the surveillance camera image may be achieved by using an image analysis system 40 to be described below.

Note that, the above exemplified technique is merely one example, and the acquisition unit 11 may determine a location where a user is present by using another technique such as a beacon.

### —Analysis of Surveillance Camera Image—

Information indicating an installation location (image-capture location) of each of a plurality of the surveillance cameras 30 is previously registered in the route computation apparatus 10. The acquisition unit 11 determines, based on the information, a surveillance camera 30 capturing an image of a location where a user is present. Then, the acquisition unit 11 analyzes a surveillance camera image generated by the determined surveillance camera 30, and generates people distribution information.

Analysis of a surveillance camera image is performed by the image analysis system 40 previously arranged. As illustrated in FIG. 5, the acquisition unit 11 inputs a surveillance camera image to the image analysis system 40. Then, the acquisition unit 11 acquires, from the image analysis system 40, an analysis result of the surveillance camera image. The image analysis system 40 may be a part of the route computation apparatus 10, or may be an external apparatus physically and/or logically independent of the route computation apparatus 10.

Herein, the image analysis system 40 is described. The image analysis system 40 includes at least one of a face recognition function, a human figure recognition function, a pose recognition function, a motion recognition function, an appearance attribute recognition function, a gradient feature detection function of an image, a color feature detection function of an image, an object recognition function, and a character recognition function.

In the face recognition function, a face feature value of a person is extracted. Further, similarity between face feature values may be collated/computed (determination whether to be the same person or the like). Further, the extracted face feature value and face feature values of a plurality of users previously registered in a database are collated with each other, and it may be determined which user a person captured in an image is. Note that, collation between the extracted face feature value and the face feature value previously registered in the database may be performed by the image analysis system 40, or may be performed by the acquisition unit 11.

In the human figure recognition function, a bodily feature value (indicating, for example, thickness/thinness of a body type and a total feature such as height and clothes) of a person is extracted. Further, similarity between bodily feature values may be collated/computed (determination whether to be the same person or the like). Further, the extracted bodily feature value and bodily feature values of a plurality of users previously registered in a database are collated with each other, and it may be determined which person a person captured in an image is. Note that, collation between the extracted bodily feature value and the bodily feature value previously registered in the database may be performed by the image analysis system 40, or may be performed by the acquisition unit 11.

In the pose recognition function and the motion recognition function, a joint point of a person is detected, and a stick human model is configured by connecting the joints points. Then, based on the stick human model, a person is detected, a height of a person is estimated, a feature value of a pose is extracted, and a motion is determined based on a change of a pose. Further, similarity between feature values of poses or similarity between feature values of motions may be collated/computed (determination whether to be the same pose or the same motion, and the like). Further, the estimated height and heights of a plurality of users previously registered in a database are collated with each other, and it may be determined which user a person captured in an image is. Note that, collation between the estimated height and the height previously registered in the database may be performed by the image analysis system 40, or may be performed by the acquisition unit 11. The pose recognition function and the motion recognition function may be achieved by the techniques disclosed in Patent Document 2 and Non-Patent Document 1.

In the appearance attribute recognition function, an appearance attribute (e.g., a clothing color, a shoe color, a hair style, wearing of a hat, a necktie, and the like; for example, there are appearance attributes of one hundred or more types in total) associated with a person is recognized. Further, similarity in recognized appearance attributes may be collated/computed (determination whether to be the same attribute is possible). Further, the recognized appearance attribute and appearance attributes of a plurality of users previously registered in a database are collated with each other, and it may be determined which user a person captured in an image is. Note that, the collation between the recognized appearance attribute and the appearance attribute previously registered in the database may be performed by the image analysis system 40, or may be performed by the acquisition unit 11.

The gradient feature detection function of an image includes SIFT, SURF, RIFF, ORB, BRISK, CARD, HOG, and the like. According to the function, a gradient feature of each frame image is detected.

In the color feature detection function of an image, data indicating a feature of a color of an image, for example, such as a color histogram are generated. According to the function, a color feature of each frame image is detected.

The object recognition function is achieved by using an engine, for example, such as YOLO (extraction of a general object [e.g., a tool, a facility, and the like used in sports and another performance] or extraction of a person can be performed). The object recognition function is used, and thereby various types of objects can be detected from an image.

In the character recognition function, a number, a letter, and the like are recognized.

The acquisition unit 11 acquires, from the image analysis system 40 as described above, as an analysis result, a detection result of a person in a surveillance camera image. In the analysis result, a location in the surveillance camera image of each of persons detected in the surveillance camera image is indicated.

### —Generation of People Distribution Information—

The acquisition unit 11 generates, based on the analysis result, people distribution information. Note that, the image analysis system 40 may generate people distribution information.

The people distribution information indicates a distribution state of persons in a passageway through which a user travels. In other words, the people distribution information indicates in what location on a passageway through which a user travels a person is present. In the people distribution information, a location of a person may be indicated based on coordinates (coordinates on an image) in a coordinate system set in a surveillance camera image. Further, a location of a person may be indicated based on coordinates (coordinates on a real space) in a coordinate system set in a real space. Conversion from coordinates on an image into coordinates on a real space can be achieved by using any technique.

Referring back to FIG. 1, the computation unit 12 computes, based on people distribution information acquired by the acquisition unit 11, a preferable route satisfying a condition (hereinafter, may be a “route condition”) defined based on a distance to another person, the preferable route being a route on a passageway, through which a user travels, indicating a travel location in a width direction of the passageway.

The passageway broadens in the width direction (a right and left direction toward a stretching direction of the passageway). Therefore, in a case where traveling is made on the passageway, there are various options such as “traveling is made at a right end of the passageway”, “traveling is made at a left end of the passageway”, and “traveling is made in a middle of the passageway”. Further, there are an option in which traveling is made while the travel location is retained, and an option in which traveling is made while the travel location is changed (while the travel location is changed in a right and left direction toward a travel direction). The preferable route is a route on the passageway through which a user travels, and indicates through what location on the passageway broadening in the width direction traveling is made. The preferable route can be referred to as a route indicating a travel location in the width direction of the passageway in each of a plurality of points along the travel direction of the passageway.

The computation unit 12 computes a preferable route on a passageway captured in a surveillance camera image. According to the second example embodiment, the computation unit 12 cannot recognize a distribution state of persons in a passageway not being captured in a surveillance camera image. Therefore, the computation unit 12 cannot compute a preferable route on a passageway not being captured in a surveillance camera image.

Further, according to the second example embodiment, the computation unit 12 computes a distance between a user and another person, assuming that a location of a person on a passageway is fixed in a location indicated by people distribution information, and executes various types of processing. Note that, according to the following example embodiments, an example in which, by considering a change of a location of a person on a passageway, a distance between a user and another person is computed and various types of processing are executed is described.

There are various types of processing of computing a preferable route satisfying a route condition, and such processing may be achieved by using a technique, for example, such as machine learning. Hereinafter, one example of processing of computing a preferable route satisfying a route condition is described.

As one example, the computation unit 12 may compute, based on a predetermined rule, a plurality of routes on a passageway. Then, the computation unit 12 may determine, as a preferable route, a route satisfying a route condition among the computed routes.

First, one example of processing of computing, based on a predetermined rule, a route on a passageway is described. The computation unit 12 may determine, as illustrated in FIG. 6, in any target location on a passageway, what point of the passageway broadening in the width direction is passed. Then, the computation unit 12 may determine, while the target location is shifted in a stretching direction of the passageway, what point of the passageway broadening in the width direction is passed in each of a plurality of target locations. Then, the computation unit 12 may determine a route by connecting passing points determined in each of the plurality of target locations.

The computation unit 12 determines, as a passing point in a target location, a “point where a distance to another person can be ensured at equal to or more than a threshold value”. The computation unit 12 may determine, as a passing point in a target location, for example, a “point where a distance from a passing point of a neighboring target location is smallest” among “points where a distance to another person can be ensured at equal to or more than a threshold value”.

In a case where it is assumed that a right end of a passageway in a certain target location is set as a passing point and a left end of the passageway is set as a passing point in a target location immediately after the former, a movement amount in the width direction of the passageway from the certain target location to the target location immediately after the former is increased, and an unnatural route is to be determined. Therefore, the computation unit 12 may determine a passing point in each target location in such a way as to satisfy a condition in that a “distance in the width direction of a passageway from a passing point of a neighboring target location is equal to or less than a lower limit”. The lower limit is determined based on a size in the width direction of a passageway, a distance to a neighboring target location, or the like.

Note that, in a case where, in a target location, a “point where a distance to another person can be ensured at equal to or more than a threshold value” is not present, the computation unit 12 may determine, as a passing point in the target location, a “point where a distance to another person is largest”, may determine a “point where a distance from a passing point of a neighboring target location is smallest”, or may determine, based on another criterion.

A distance (gap) to a neighboring target location is a design matter. In a case where the distance to a neighboring target location is decreased, a more-accurate preferable route can be computed, but a processing load on a computer is increased.

Further, “another person” to be considered in determination of the route may be “every person detected in a surveillance camera image”, may be a “person present on a passageway among persons detected in a surveillance camera image”, or may be a “person detected in a surveillance camera image, the person being present on a passageway and being with a travel direction opposite to a travel direction of a user”. The travel direction may be determined based on an orientation of a body or a face determined from a surveillance camera image (for example, an orientation of a body or a face is a travel direction), or may be determined based on a movement track in a moving image in a case where a surveillance camera image is a moving image.

Next, a “route condition” satisfied by a preferable route is described. The route condition is that a “reference retention state in which a distance to another person is equal to or more than a threshold value can be retained at a reference level or more”.

“Another person” in the route condition has the same definition as “another person” to be considered in determination of the above-described route.

The route condition more specifically is that the reference retention rate is equal to or more than a reference level, the reference retention rate being:

a “ratio, to the number of other persons passing a user, of the number of other persons in which a reference retention state where a distance to the user is equal to or more than a threshold value is retained”,

a “ratio, to a movement distance, of a distance to a point in which a reference retention state where a distance to another person is equal to or more than a threshold value is retained”, or

a “ratio, to a movement time, of a time in which a reference retention state where a distance to another person is equal to or more than a threshold value is retained”.

The “number of other persons passing a user” may be, for example, the number of other persons defined as described above.

The “number of other persons in which a reference retention state where a distance to a user is equal to or more than a threshold value is retained” is the number of persons, among other persons, in which, in a case where a user moves in a determined route, a reference retention state where a distance to the user is equal to or more than a threshold value continues to be retained (persons in which a distance to the user is never less than the threshold value).

The “movement distance” is a movement distance of a determined route. A length of a route on a surveillance camera image may be computed as the movement distance, or a length of a route on a real space may be computed as the movement distance.

The “distance to a point in which a reference retention state where a distance to another person is equal to or more than a threshold value is retained” is a distance to a point in which, in a case where a user moves in a determined route, a reference retention state where a distance to another person is equal to or more than a threshold value is retained. A length of the point on a surveillance camera image may be computed, or a length of the point on a real space may be computed.

The “movement time” is a time required by a user to move in a determined route. For example, assuming that a user moves at a general walking velocity, the movement time may be computed.

The “time in which a reference retention state where a distance to another person is equal to or more than a threshold value is retained” is a time in which, in a case where a user moves in a determined route, a reference retention state where a distance to another person is equal to or more than a threshold value is retained. For example, assuming that a user moves at a general walking velocity, the time may be computed.

The output unit 13 outputs preferable route information indicating a preferable route computed by the computation unit 12. The preferable route information output by the output unit 13 is transmitted to the user terminal 20, and is displayed on a display of the user terminal 20. For example, the computation unit 12 can generate preferable route information.

The output unit 13 may output, as illustrated in FIG. 3, preferable route information in which information indicating a preferable route is superimposed on a surveillance camera image. Travel routes 1 and 2 in FIG. 3 each are a preferable route. The computation unit 12 superimposes, on a surveillance camera image, information indicating a preferable route on a predetermined location, and generates preferable route information.

Further, the output unit 13 may output, as illustrated in FIG. 7, preferable route information in which information indicating a preferable route is superimposed on a map. Travel routes 1 and 2 in FIG. 7 each are a preferable route. The computation unit 12 superimposes information indicating a preferable route on a predetermined location on map data previously stored, and generates preferable route information.

Further, the output unit 13 may output, as illustrated in FIG. 8, preferable route information in which information indicating a location of a person indicated by people distribution information is further superimposed on the map in FIG. 7. Travel routes 1 and 2 in FIG. 8 each are a preferable route, and a location of a person is indicated by a mark in which a cross is displayed in a circle. The computation unit 12 superimposes information indicating a preferable route and information indicating a location of a person indicated by people distribution information on a predetermined location on map data previously stored, and generates preferable route information.

Further, the output unit 13 may output, as illustrated in FIG. 9, preferable route information further indicating a reference retention rate of a preferable route. A definition of the reference retention rate is as described above. In FIG. 9, a reference retention rate of a preferable route is indicated in the preferable route information in FIG. 3, but a reference retention rate of a preferable route may be indicated in the preferable route information in FIG. 7 or FIG. 8.

Next, by using a flowchart in FIG. 10, one example of a flow of processing of the route computation apparatus 10 is described.

First, the acquisition unit 11 acquires people distribution information in a passageway through which a user travels (S10). The acquisition unit 11 determines, for example, by using a current location positioning function mounted on the user terminal 20 carried by a user, a current location of the user. Then, the acquisition unit 11 determines a surveillance camera 30 capturing an image of the determined current location of the user, analyzes a surveillance camera image generated by the determined surveillance camera 30, and generates people distribution information.

Next, the computation unit 12 computes, based on the people distribution information acquired in S10, a preferable route satisfying a route condition defined based on a distance to another person, the preferable route being a route on a passageway, through which a user travels, indicating a travel location in the width direction of the passageway (S11). The route condition is that a reference retention rate, for example, is equal to or more than a reference level, the reference retention rate being a “ratio, to the number of other persons passing a user, of the number of other persons in which a reference retention state where a distance to the user is equal to or more than a threshold value is retained”, a “ratio, to a movement distance, of a distance to a point in which a reference retention state where a distance to another person is equal to or more than a threshold value is retained”, or a “ratio, to a movement time, of a time in which a reference retention state where a distance to another person is equal to or more than a threshold value is retained”.

Then, the output unit 13 outputs preferable route information indicating the preferable route computed in S11 (S12). The output unit 13 outputs the preferable route information, for example, as illustrated in FIG. 3, 7, 8, or 9. The preferable route information output by the output unit 13 is transmitted to the user terminal 20, and is displayed on a display of the user terminal 20.

Note that, the route computation apparatus 10 can repeatedly execute the processing from S10 to S12 described above. In association with movement of a user, in a case where a current location of the user changes, the route computation apparatus 10 newly determines a surveillance camera 30 capturing an image of a current location of the user after the movement, analyzes a surveillance camera image generated by the newly-determined surveillance camera 30, and thereby newly generates people distribution information (S10). Thereafter, the route computation apparatus 10 executes the above-described processing in S11 and S12.

### “Advantageous Effect”

According to the route computation apparatus 10 of the second example embodiment, a surveillance camera image is analyzed, people distribution information indicating a distribution state of persons in a passageway through which a user travels is generated, and thereby a preferable route on the passage way can be computed based on the information. Generally, a surveillance camera captures an image of a passageway from an upper side, and therefore, an image indicating a situation of the entire passageway can be generated. Based on such a surveillance camera image, a distribution state of persons in a passageway is recognized and a preferable route on the passageway is computed, and thereby a preferable route with high accuracy can be computed.

Further, a preferable route satisfying a route condition in that a reference retention rate is equal to or more than a reference level is computed, the reference retention rate being a “ratio, to the number of other persons passing a user, of the number of other persons in which a reference retention state where a distance to the user is equal to or more than a threshold value is retained”, a “ratio, to a movement distance, of a distance to a point in which a reference retention state where a distance to another person is equal to or more than a threshold value is retained”, or a “ratio, to a movement time, of a time in which a reference retention state where a distance to another person is equal to or more than a threshold value is retained”, and thereby a preferable route in which a distance to another person is sufficiently retained can be computed.

Further, preferable route information in which, on a surveillance camera image as illustrated in FIG. 3, 7, 8, or 9 or on a map, information indicating a preferable route is superimposed is output, and thereby a user can intuitively recognize the preferable route. Furthermore, as illustrated in FIG. 3, 8, or 9, a person present on a passageway is further indicated, and thereby a user can determine adequacy of the computed preferable route. Further, as illustrated in FIG. 9, a reference retention rate of each preferable route is further indicated, and thereby a user can determine which one of a plurality of preferable routes is preferable.

### Third Example Embodiment

According to the second example embodiment, the computation unit 12 computes a distance to another person, assuming that a location of a person on a passageway is fixed in a location indicated people distribution information, and executes various types of processing. According to a third example embodiment, a computation unit 12 computes, by considering a change of a location of a person on a passageway, a distance between a user and another person, and executes various types of processing. Hereinafter, details are described.

An acquisition unit 11 analyzes a surveillance camera image in which an image of a passageway is captured, and, based on an analysis result, generates people distribution information indicating a distribution state of persons in the passageway after a lapse of a predetermined time from timing of capturing the surveillance camera image (after several frames from the surveillance camera image). Then, the computation unit 12 computes, based on the people distribution information, a preferable route. The predetermined time is, for example, approximately several seconds.

A location of each of a plurality of persons on the passageway after a lapse of the predetermined time from timing of capturing the surveillance camera image is computed based on a location of each of a plurality of persons at timing of capturing the surveillance camera image, a travel direction of each of a plurality of persons, and a travel velocity of each of a plurality of persons. For example, a location of a certain person after a lapse of the predetermined time from timing of capturing the surveillance camera image can be set as a location reached after movement during the predetermined time at a travel velocity of the person in the travel direction of the person from a location of the person at the timing of capturing the surveillance camera image.

Note that, a general walking velocity may be used as a travel velocity of each of a plurality of persons, or a surveillance camera image (moving image) may be analyzed and an actual travel velocity of each of a plurality of persons may be computed. Further, the travel direction of each of a plurality of persons may be computed, assuming that the travel direction is a stretching direction of a passageway (i.e., assuming that straight traveling is made along a passageway, and traveling is not made obliquely or traveling is not made in a width direction). Note that, in the stretching direction of a passageway, a direction of a body or a face of each of a plurality of persons determined from a surveillance camera image can be set as the travel direction of a user. Further, a surveillance camera image (moving image) is analyzed and a movement track of each of a plurality of persons is computed, and thereby the travel direction at timing of capturing the surveillance camera image may be computed.

The computation unit 12 computes a preferable route, by further using people distribution information indicating a distribution state of persons in a passageway after a lapse of a predetermined time from timing of capturing the surveillance camera image.

For example, as described by using FIG. 6, the computation unit 12 can determine, while a target location is shifted in the stretching direction of a passageway, what point of the passageway broadening in the width direction is passed in each of a plurality of target locations, and thereby, can determine a route by connecting passing points determined in each of the plurality of target locations. In this case, the computation unit 12 determines timing at which a user reaches each of the plurality of target locations, and thereby, can determine, by using people distribution information relevant to each piece of determined timing, what point of the passageway broadening in the width direction is passed in each target location.

The “timing at which a user reaches each of a plurality of target locations” is represented as a form of after a predetermined time lapse from timing of capturing the surveillance camera image. A value of the predetermined time is computed based on a location of a user at the timing of capturing the surveillance camera image, a distance between the location and each of a plurality of target locations, and a travel velocity of the user.

A general walking velocity may be used as a travel velocity of a user, or a surveillance camera image (moving image) may be analyzed and an actual travel velocity of a user may be computed. Further, the travel direction of a user may be computed, assuming that the travel direction is the stretching direction of a passageway (i.e., assuming that straight traveling is made along a passageway, and traveling is not made obliquely or traveling is not made in the width direction). Note that, in the stretching direction of a passageway, a direction of a body or a face of a user determined from a surveillance camera image can be set as the travel direction of the user.

Further, the computation unit 12 uses, also in processing of determining whether a determined route satisfies a route condition, people distribution information relevant to each piece of timing generated by the acquisition unit 11. Specifically, the computation unit 12 determines timing at which a user reaches each point on a route, and determines, based on the people distribution information relevant to each piece of timing generated by the acquisition unit 11, a people distribution state on a passageway at each piece of timing. Then, the computation unit 12 determines whether a distance to another person is equal to or more than a threshold value at a time when the user passes through each point on the route.

Other configurations of a route computation apparatus 10 are similar to those of the first and second example embodiments.

According to the route computation apparatus 10 of the third example embodiment, an advantageous effect similar to the first and second example embodiments is achieved. Further, according to the route computation apparatus 10 of the third example embodiment that computes, by considering a change of a location of a person on a passageway, a distance between a user and another person and executes various types of processing, a preferable route with higher accuracy can be computed.

### Fourth Example Embodiment

According to the second and third example embodiments, a “passageway through which a user travels” is a “passageway where a user is present”. According to a fourth example embodiment, a “passageway through which a user travels” is an “optimal passageway through which traveling is made in order to go from a start point to a goal point searched for based on a passageway search technique.

Then, according to the second and third example embodiments, “people distribution information” is “real-time information generated by analyzing a surveillance camera image in which an image of a passageway where a user is present is captured”. According to the fourth example embodiment, “people distribution information” is “information indicating a past tendency generated by analyzing a surveillance camera image in which a passageway through which a user travels is captured”.

A route computation apparatus 10 according to the fourth example embodiment is different from the route computation apparatus 10 according to the second and third example embodiments in the above-described point. Hereinafter, details are described.

An acquisition unit 11 acquires people distribution information indicating a past tendency of a distribution state of persons in a passageway through which a user travels.

According to the fourth example embodiment, the “passageway through which a user travels” is an “optimal passageway through which traveling is made in order to go from a start point to a goal point searched for based on a passageway search technique”. By using a well-known passageway search technique, an optimal passageway through which traveling is made in order to go from a start point to a goal point set by a user is searched. Then, the acquisition unit 11 acquires information indicating the searched passageway. Note that, the start point may be set by a user, or a current point of a user may be a start point. The current point of a user is determined based on any well-known technique. Optimal passageway search may be performed by the route computation apparatus 10, or may be performed by an external apparatus physically and/or logically separated from the route computation apparatus 10.

The acquisition unit 11 previously generates people distribution information indicating a past tendency of a distribution state of persons in each of a plurality of passageways, and registers the generated people distribution information in a storage apparatus. Then, the acquisition unit 11 acquires, from the storage apparatus, people distribution information indicating the past tendency of a distribution state of persons in a passageway through which a user travels. FIG. 11 illustrates one example of a people distribution state generated by the acquisition unit 11, and in the illustrated example, an area on a passageway is classified into (1) an area of a large congestion degree, (2) an area of a small congestion degree, and (3) an area of a medium congestion degree. Note that, a method for classification into three-stage congestion degrees in this manner is merely one example, but not limited thereto.

The acquisition unit 11 inputs, to an image analysis system 40, a past surveillance camera image generated by a surveillance camera 30, and generates information indicating a location of a person on a passageway in each past time. Then, the acquisition unit 11 statistically processes the information relevant to a plurality of past times, and generates people distribution information indicating a past tendency of a distribution state of people in each of passageways.

Note that, the acquisition unit 11 may divide into cases, based on a factor which may influence a distribution state of persons such as every day of week, every month, every time period, and every weather, and thereby, generate people distribution information relevant to each case.

A computation unit 12 computes a preferable route on a passageway through which a user travels, based on people distribution information according to the fourth example embodiment as described above. The computation unit 12 computes a preferable route passing through a location where the congestion degree is small. Note that, in a case where the acquisition unit 11 divides into cases, based on a factor which may influence a distribution state of persons such as every day of week, every month, every time period, and every weather, and generates people distribution information relevant to each case, the computation unit 12 determines a case to which timing at which a user travels through a passageway is relevant, and determines a preferable route, based on people distribution information relevant to the determined case.

The acquisition unit 11 may determine a current time as “timing at which a user travels through a passageway”. Further, a user may specify timing at which the user travels through the passageway. For example, a user may specify, in passageway search, a start date and time and an arrival date and time, in addition to a goal point. Then, the acquisition unit 11 may determine, based on the start date and time and the arrival date and time specified by the user, the “timing at which the user travels through a passageway”.

Other configurations of the route computation apparatus 10 are similar to those of the first to third example embodiments.

According to the route computation apparatus 10 of the fourth example embodiment, an advantageous effect similar to the first to third example embodiments is achieved. Further, according to the route computation apparatus 10 of the fourth example embodiment that computes a preferable route, based on people distribution information indicating a past tendency of a distribution state of persons in a passageway, while traveling is made through each passageway, notification of through what location on a passageway traveling is preferably made can be made to a user in advance, instead of a time at which the user is present in the location. Since the notification is made in advance, a user can perform preparation of traveling in advance.

### <Modified Example>

Hereinafter, a modified example applicable to the route computation apparatus 10 according to the first to fourth example embodiments is described.

The acquisition unit 11 may analyze a surveillance camera image, and determine an obstacle on a passageway. Then, the acquisition unit 11 may compute a preferable route passing by avoiding the obstacle.

In a case where the modified example is applied to the fourth example embodiment, an object which does not move and is always present on a passageway such as a bench and a post may be previously registered as an obstacle, and may be detected from an image-capture camera image.

On the other hand, in a case where the modified example is applied to the second and third example embodiments, in addition to an object which does not move and is always present on a passageway such as a bench and a post, an object temporarily present on a passageway such as an automobile and a truck being stopped may also be previously registered as an obstacle, and may be detected from an image-capture camera image.

Also, in the modified example, an advantageous effect similar to the first to fourth example embodiments is achieved. Further, according to the modified example, a preferable route passing by avoiding an obstacle can be computed.

While with reference to the accompanying drawings, the example embodiments according to the present invention have been described, the example embodiments are exemplification of the present invention, and various configurations other than the above-described configurations are employable. The configurations according to the above-described example embodiments may be combined with each other, and a part of a configuration may be replaced with another configuration. Further, the configurations according to the above-described example embodiments may be added with various modifications to an extent without departing from the gist of the present invention. Further, configurations and processing disclosed according to the example embodiments and the modified example described above may be combined with each other.

Further, in the flowchart used in the above-described description, a plurality of steps (pieces of processing) are described in order, but an execution order of steps to be executed according to each example embodiment is not limited to the described order. According to each example embodiment, an order of illustrated steps can be modified within an extent that there is no harm in context. Further, the above-described example embodiments can be combined within an extent that there is no conflict in content.

The whole or part of the example embodiments described above can be described as, but not limited to, the following supplementary notes.

1. A route computation apparatus including:

an acquisition unit that acquires people distribution information indicating a distribution state of persons in a passageway through which a user travels;

a computation unit that computes, based on the people distribution information, a preferable route, on the passageway, satisfying a condition defined based on a distance to another person, the preferable route being a route on the passageway indicating a travel location in a width direction of the passageway; and

an output unit that outputs preferable route information indicating the computed preferable route.

2. The route computation apparatus according to supplementary note 1, wherein

the acquisition unit analyzes an image capturing the passageway, and generates, based on an analysis result, the people distribution information.

3. The route computation apparatus according to supplementary note 1 or 2, wherein

the acquisition unit analyzes an image capturing the passageway, and generates, based on an analysis result, the people distribution information indicating a distribution state of persons in the passageway after a lapse of a predetermined time from timing of capturing the image.

4. The route computation apparatus according to any one of supplementary notes 1 to 3, wherein

the acquisition unit acquires the person distribution information indicating a past tendency of a distribution state of persons in the passageway.

5. The route computation apparatus according to any one of supplementary notes 1 to 4, wherein

the condition is that a reference retention state where a distance to another person is equal to or more than a threshold value is retained at equal to or more than a reference level.

6. The route computation apparatus according to supplementary note 5, wherein

the condition is that a reference retention rate is equal to or more than the reference level, the reference retention rate being
a ratio, to the number of other persons passing the user, of the number of other persons in which the reference retention state where a distance to the user is equal to or more than a threshold value is retained,
a ratio, to a movement distance, of a distance to a point in which the reference retention state where a distance to another person is equal to or more than a threshold value is retained, or
a ratio, to a movement time, of a time in which the reference retention state where a distance to another person is equal to or more than a threshold value is retained.
   7. The route computation apparatus according to supplementary note 6, wherein

the output unit outputs the preferable route information further indicating the reference retention rate of the preferable route.

8. The route computation apparatus according to any one of supplementary notes 1 to 7, wherein

the preferable route is a route indicating a travel location in a width direction of the passageway in each of a plurality of points along a travel direction of the passageway.

9. A route computation method including,

by a computer:
acquiring people distribution information indicating a distribution state of persons in a passageway through which a user travels;
computing, based on the people distribution information, a preferable route, on the passageway, satisfying a condition defined based on a distance to another person, the preferable route being a route on the passageway indicating a travel location in a width direction of the passageway; and
outputting preferable route information indicating the computed preferable route.
   10. A storage medium storing a program causing a computer to function as:

an acquisition unit that acquires people distribution information indicating a distribution state of persons in a passageway through which a user travels;

a computation unit that computes, based on the people distribution information, a preferable route, on the passageway, satisfying a condition defined based on a distance to another person, the preferable route being a route on the passageway indicating a travel location in a width direction of the passageway; and

an output unit that outputs preferable route information indicating the computed preferable route.

### REFERENCE SIGNS LIST

10 Route computation apparatus

11 Acquisition unit

12 Computation unit

13 Output unit

20 User terminal

30 Surveillance camera

40 Image analysis system

1A Processor

2A Memory

3A Input/output I/F

4A Peripheral circuit

5A Bus

What is claimed is:

1. A route computation apparatus comprising:
at least one memory configured to store one or more instructions; and
at least one processor configured to execute the one or more instructions to:
acquire people distribution information indicating a distribution state of persons in a passageway through which a user travels;
compute, based on the people distribution information, a preferable route, on the passageway, satisfying a condition defined based on a distance to another person, the preferable route being a route on the passageway indicating a travel location in a width direction of the passageway; and
output preferable route information indicating the computed preferable route,
wherein the condition is that a reference retention state where a distance to another person is equal to or more than a threshold value is retained at equal to or more than a reference level.

2. The route computation apparatus according to claim 1, wherein
the at least one processor is further configured to execute the one or more instructions to analyze an image capturing the passageway, and generate, based on an analysis result, the people distribution information.

3. The route computation apparatus according to claim 1, wherein
the at least one processor is further configured to execute the one or more instructions to analyze an image capturing the passageway, and generate, based on an analysis result, the people distribution information indicating a distribution state of persons in the passageway after a lapse of a predetermined time from timing of capturing the image.

4. The route computation apparatus according to claim 1, wherein
the at least one processor is further configured to execute the one or more instructions to acquire the person distribution information indicating a past tendency of a distribution state of persons in the passageway.

5. (canceled)

6. The route computation apparatus according to claim 1, wherein
the condition is that a reference retention rate is equal to or more than the reference level, the reference retention rate being
a ratio, to a number of other persons passing the user, of a number of other persons in which the reference retention state where a distance to the user is equal to or more than a threshold value is retained,
a ratio, to a movement distance, of a distance to a point in which the reference retention state where a distance to another person is equal to or more than a threshold value is retained, or
a ratio, to a movement time, of a time in which the reference retention state where a distance to another person is equal to or more than a threshold value is retained.

7. The route computation apparatus according to claim 6, wherein
the at least one processor is further configured to execute the one or more instructions to output the preferable route information further indicating the reference retention rate of the preferable route.

8. The route computation apparatus according to claim 1, wherein
the preferable route is a route indicating a travel location in a width direction of the passageway in each of a plurality of points along a travel direction of the passageway.

9. A route computation method comprising,
by a computer:
acquiring people distribution information indicating a distribution state of persons in a passageway through which a user travels;
computing, based on the people distribution information, a preferable route, on the passageway, satisfying a condition defined based on a distance to another person, the preferable route being a route on the passageway indicating a travel location in a width direction of the passageway; and
outputting preferable route information indicating the computed preferable route,
wherein the condition is that a reference retention state where a distance to another person is equal to or more than a threshold value is retained at equal to or more than a reference level.

10. A non-transitory storage medium storing a program causing a computer to:
acquire people distribution information indicating a distribution state of persons in a passageway through which a user travels;
compute, based on the people distribution information, a preferable route, on the passageway, satisfying a condition defined based on a distance to another person, the preferable route being a route on the passageway indicating a travel location in a width direction of the passageway; and
output preferable route information indicating the computed preferable route,
wherein the condition is that a reference retention state where a distance to another person is equal to or more than a threshold value is retained at equal to or more than a reference level.

11. The route computation method according to claim 9, wherein
the computer analyzes an image capturing the passageway, and generates, based on an analysis result, the people distribution information.

12. The route computation method according to claim 9, wherein
the computer analyzes an image capturing the passageway, and generates, based on an analysis result, the people distribution information indicating a distribution state of persons in the passageway after a lapse of a predetermined time from timing of capturing the image.

13. The route computation method according to claim 9, wherein
the computer acquires the person distribution information indicating a past tendency of a distribution state of persons in the passageway.

14. The route computation method according to claim 9, wherein
the condition is that a reference retention rate is equal to or more than the reference level, the reference retention rate being
a ratio, to a number of other persons passing the user, of a number of other persons in which the reference retention state where a distance to the user is equal to or more than a threshold value is retained,
a ratio, to a movement distance, of a distance to a point in which the reference retention state where a distance to another person is equal to or more than a threshold value is retained, or
a ratio, to a movement time, of a time in which the reference retention state where a distance to another person is equal to or more than a threshold value is retained.

15. The route computation method according to claim 14, wherein
the computer outputs the preferable route information further indicating the reference retention rate of the preferable route.

16. The non-transitory storage medium according to claim 10, wherein
the program causing the computer to analyze an image capturing the passageway, and generate, based on an analysis result, the people distribution information.

17. The non-transitory storage medium according to claim 10, wherein
the program causing the computer to analyze an image capturing the passageway, and generate, based on an analysis result, the people distribution information indicating a distribution state of persons in the passageway after a lapse of a predetermined time from timing of capturing the image.

18. The non-transitory storage medium according to claim 10, wherein
the program causing the computer to acquire the person distribution information indicating a past tendency of a distribution state of persons in the passageway.

19. The non-transitory storage medium according to claim 10, wherein
the condition is that a reference retention rate is equal to or more than the reference level, the reference retention rate being
a ratio, to a number of other persons passing the user, of a number of other persons in which the reference retention state where a distance to the user is equal to or more than a threshold value is retained,
a ratio, to a movement distance, of a distance to a point in which the reference retention state where a distance to another person is equal to or more than a threshold value is retained, or
a ratio, to a movement time, of a time in which the reference retention state where a distance to another person is equal to or more than a threshold value is retained.

20. The non-transitory storage medium according to claim 19, wherein
the program causing the computer to output the preferable route information further indicating the reference retention rate of the preferable route.
